(19) United States
(12) Patent Application Publication
(10) Pub. No.: US 2020/0310436 A1
(43) Pub. Date: Oct. 1, 2020

(54) ENHANCED VEHICLE LOCALIZATION AND NAVIGATION

(71) Applicant: Ford Global Technologies, LLC, Dearborn, MI (US)

(72) Inventors: SMRUTI PANIGRAHI, Farmington Hills, MI (US); JUSTIN MILLER, Royal Oak, MI (US); SANGHYUN HONG, Ann Arbor, MI (US); JIANBO LU, Northville, MI (US)

(73) Assignee: Ford Global Technologies, LLC, Dearborn, MI (US)

(21) Appl. No.: 16/363,456

(22) Filed: Mar. 25, 2019

(51) Int. Cl. G05D 1/02; H04W 4/44; H04W 4/029

(52) U.S. Cl. CPC G05D 1/0212; H04W 4/029; H04W 4/44; G05D 1/0246

(57) ABSTRACT

A computer includes a processor and a memory, the memory including instructions executable by the processor to identify a mobile vehicle position based on global position coordinates of a stationary location transmitter and a localized trajectory of a vehicle that is based on vehicle component data collected after passing the stationary location transmitter and to actuate a vehicle component based on the identified vehicle position.

### BACKGROUND

Autonomous vehicles typically navigate with high-resolution maps that can be stored in vehicle computers to generate routes for the vehicles to follow. The high-resolution maps may be updated in real time over a remote network. The high-resolution maps may be computationally intensive for the vehicle computer to generate and to use to move the vehicle along the route.

### BRIEF DESCRIPTION OF THE DRAWINGS

FIG. 1 is a block diagram of an example system for operating a vehicle.

FIGS. 2A-2B are plan views of a vehicle entering a broadcast radius of a location transmitter.

FIGS. 3A-3B are plan views of a vehicle identifying a pattern on a location transmitter.

FIGS. 4A-4B are plan views of a vehicle passing a landmark.

FIG. 5 is a block diagram of an example process for identifying a vehicle position based on the broadcast radius of the location transmitter.

FIG. 6 is a block diagram of an example process for identifying the vehicle position based on the pattern on the location transmitter.

FIG. 7 is a block diagram of an example process for identifying the vehicle position based on the landmark.

### DETAILED DESCRIPTION

A system includes a computer including a processor and a memory, the memory including instructions executable by the processor to identify a mobile vehicle position based on global position coordinates of a stationary location transmitter and a localized trajectory of a vehicle that is based on vehicle component data collected after passing the stationary location transmitter and to actuate a vehicle component based on the identified vehicle position.

The instructions can further include instructions to determine the localized trajectory upon determining that the vehicle has entered a broadcast radius of the location transmitter.

The instructions can further include instructions to determine the localized trajectory upon detection of the location transmitter in an image.

The instructions can further include instructions to identify a pattern with the image sensor and to determine the localized trajectory based on global position coordinates corresponding to the location transmitter associated with the pattern.

The instructions can further include instructions to determine the localized trajectory based on global position coordinates from a previously identified location transmitter.

The instructions can further include instructions to determine the localized trajectory based on a vehicle speed identified after receiving the global position coordinates from the previously identified location transmitter.

The instructions can further include instructions to determine the localized trajectory based on wheel rotation data.

The instructions can further include instructions to determine a second localized trajectory based on global position coordinates of the vehicle and to actuate a component to move the vehicle along the second localized trajectory when a difference between the localized trajectory and the second localized trajectory exceeds a threshold.

The instructions can further include instructions to determine a second localized trajectory based on the identified vehicle position.

The instructions can further include instructions to determine a path from an origin to a destination and to adjust the path based on the global position coordinates of the location transmitter.

The location transmitter can be fixed to infrastructure.

The instructions can further include instructions to determine the localized trajectory upon determining that the vehicle is not in a turn.

A method includes identifying a mobile vehicle position based on global position coordinates of a stationary location transmitter and a localized trajectory of a vehicle that is based on vehicle component data collected after passing the stationary location transmitter and actuating a vehicle component based on the identified vehicle position.

The method can further include determining the localized trajectory upon determining that the vehicle has entered a broadcast radius of the location transmitter.

The method can further include determining the localized trajectory upon detection of the location transmitter in an image.

The method can further include identifying a pattern with the image sensor and determining the localized trajectory based on global position coordinates corresponding to the location transmitter associated with the pattern.

The method can further include determining the localized trajectory based on global position coordinates from a previously identified location transmitter.

The method can further include determining the localized trajectory based on a vehicle speed identified after receiving the global position coordinates from the previously identified location transmitter.

The method can further include determining the localized trajectory based on wheel rotation data.

The method can further include determining a second localized trajectory based on global position coordinates of the vehicle and actuating a component to move the vehicle along the second localized trajectory when a difference between the localized trajectory and the second localized trajectory exceeds a threshold.

The method can further include determining a second localized trajectory based on the identified vehicle position.

The method can further include determining a path from an origin to a destination and to adjust the path based on the global position coordinates of the location transmitter.

The method can further include determining the localized trajectory upon determining that the vehicle is not in a turn.

A system includes a steering component of a vehicle, means for identifying a mobile vehicle position based on global position coordinates of a stationary location transmitter and a localized trajectory of a vehicle that is based on vehicle component data collected after passing the stationary location transmitter and means for actuating the steering component based on the identified vehicle position.

The system can further include means for determining the localized trajectory upon determining that the vehicle has entered a broadcast radius of the location transmitter.

The system can further include means for determining the localized trajectory upon detection of the location transmitter with an image sensor.

The system can further include means for determining the localized trajectory based on global position coordinates from a previously identified location transmitter.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

Determining a localized trajectory from an identified vehicle position allows operation of a vehicle while reducing computations performed by a vehicle computer. Providing a plurality of location transmitters in a geographic area allows the vehicle to minimize use of high-resolution maps when operating the vehicle. Identifying the vehicle position based on the location transmitters, and thereby reducing the use of high-resolution maps for operating the vehicle, thus reduces the computations performed by the vehicle computer. Further, determining the localized trajectory with vehicle component data allows the computer to quickly determine the current vehicle position based on data collected by vehicle sensors.

The location transmitters can provide their respective global position coordinates to the vehicle computer. Because the location transmitters provide the global position coordinates, the vehicle computer can identify a current vehicle position based on vehicle component data rather than computationally intensive high-resolution maps. The use of location transmitters further reduces errors in vehicle component data that may drift and reduces errors in low-resolution global position coordinate maps by providing precise landmarks off of which the vehicle computer can determine the position of the vehicle.

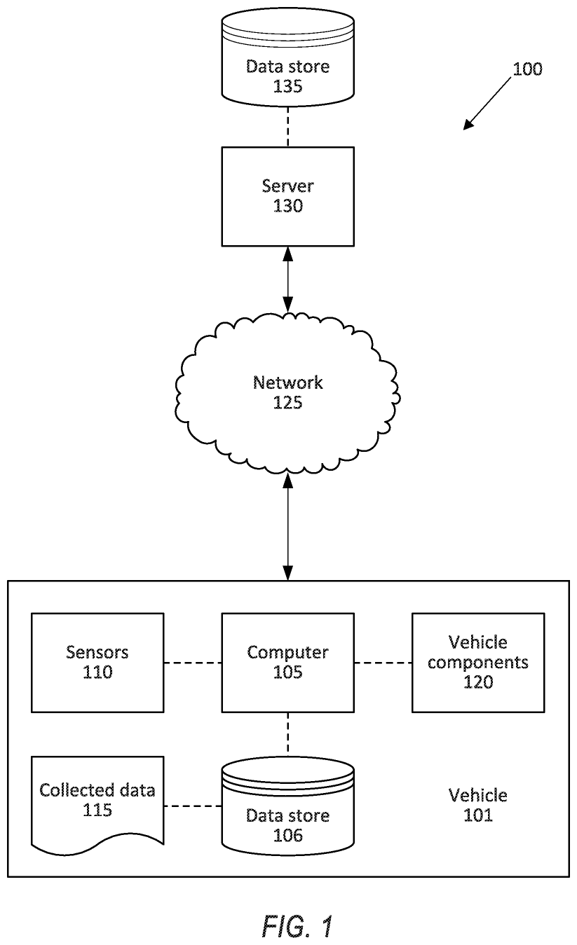

FIG. 1 illustrates an example system 100 for operating a vehicle 101. The system 100 includes a computer 105. The computer 105 included in the vehicle 101 is programmed to receive collected data 115 from one or more sensors 110. For example, vehicle 101 data 115 may include a location of the vehicle 101, data about an environment around a vehicle 101, data about an object outside the vehicle such as another vehicle, etc. A vehicle 101 location is typically provided in a conventional form, e.g., geo-coordinates such as latitude and longitude coordinates obtained via a navigation system that uses the Global Positioning System (GPS). Further examples of data 115 can include measurements of vehicle 101 systems and components, e.g., a vehicle 101 velocity, a vehicle 101 trajectory, etc.

The computer 105 is generally programmed for communications on a vehicle 101 network, e.g., including a conventional vehicle 101 communications bus. Via the network, bus, and/or other wired or wireless mechanisms (e.g., a wired or wireless local area network in the vehicle 101), the computer 105 may transmit messages to various devices in a vehicle 101 and/or receive messages from the various devices, e.g., controllers, actuators, sensors, etc., including sensors 110. Alternatively or additionally, in cases where the computer 105 actually comprises multiple devices, the vehicle network may be used for communications between devices represented as the computer 105 in this disclosure. In addition, the computer 105 may be programmed for communicating with the network 125, which, as described below, may include various wired and/or wireless networking technologies, e.g., cellular, Bluetooth®, Bluetooth® Low Energy (BLE), wired and/or wireless packet networks, etc.

The data store 106 can be of any type, e.g., hard disk drives, solid state drives, servers, or any volatile or non-volatile media. The data store 106 can store the collected data 115 sent from the sensors 110.

Sensors 110 can include a variety of devices. For example, various controllers in a vehicle 101 may operate as sensors 110 to provide data 115 via the vehicle 101 network or bus, e.g., data 115 relating to vehicle speed, acceleration, position, subsystem and/or component status, etc. Further, other sensors 110 could include cameras, motion detectors, etc., i.e., sensors 110 to provide data 115 for evaluating a position of a component, evaluating a slope of a roadway, etc. The sensors 110 could, without limitation, also include short range radar, long range radar, LIDAR, and/or ultrasonic transducers.

Collected data 115 can include a variety of data collected in a vehicle 101. Examples of collected data 115 are provided above, and moreover, data 115 are generally collected using one or more sensors 110, and may additionally include data calculated therefrom in the computer 105, and/or at the server 130. In general, collected data 115 may include any data that may be gathered by the sensors 110 and/or computed from such data.

The vehicle 101 can include a plurality of vehicle components 120. In this context, each vehicle component 120 includes one or more hardware components adapted to perform a mechanical function or operation—such as moving the vehicle 101, slowing or stopping the vehicle 101, steering the vehicle 101, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, or the like.

When the computer 105 partially or fully operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined herein as one in which each of vehicle 101 propulsion (typically via a powertrain including an electric motor and/or internal combustion engine), braking, and steering are controlled by the computer 105. A semi-autonomous mode is one in which at least one of vehicle 101 propulsion (typically via a powertrain including an electric motor and/or internal combustion engine), braking, and steering are controlled at least partly by the computer 105 as opposed to a human operator. In a non-autonomous mode, i.e., a manual mode, the vehicle 101 propulsion, braking, and steering are controlled by the human operator.

The system 100 can further include a network 125 connected to a server 130 and a data store 135. The computer 105 can further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

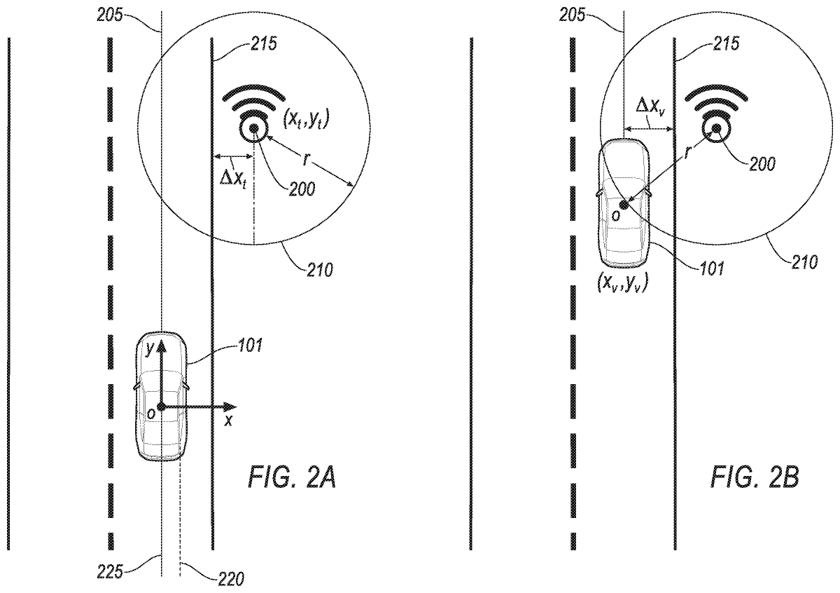

FIGS. 2A and 2B are plan views of an example vehicle 101 on a roadway with a location transmitter 200. Along the roadway, the vehicle 101 follows a path 205 from an origin to a destination. A “path” is a set of location coordinates. The computer 105 can actuate one or more components 120, e.g., with conventional virtual driver techniques, to follow to move the vehicle 101 from the origin to the destination according to a specified path 205 from the origin to the destination. An accurate position of the vehicle 101, i.e., a determined position of the vehicle 101 substantially close to the prescribed position of the vehicle 101 by the path 205, ensures that the vehicle 101 remains on the path 205. In the examples of FIGS. 2A-4B, the computer 105 uses a 2-dimensional coordinate system centered at a reference point O, e.g., a center point of the vehicle 101, and defining a lateral direction x and a longitudinal direction y. The longitudinal direction y is a vehicle-forward direction. The lateral direction x is perpendicular to the longitudinal direction y, i.e., a vehicle-crosswise direction. The computer 105 can, using known geometric and linear algebraic techniques, map global position coordinates of objects (e.g., the location transmitter 200, the vehicle 101, etc.) in the 2-dimensional coordinate system. That is, upon receiving 2-dimensional global position coordinates indicating a latitude and a longitude, the computer 105 can transform the global position coordinates into a set of (x, y) coordinates in the vehicle 101 coordinate system.

The roadway includes a location transmitter 200. The location transmitter 200 is a device that receives position coordinates over the network 125 from the server 130 and transmits the position coordinates to one or more vehicles 101. The location transmitter 200 transmits global position coordinates, e.g., from a GPS satellite, from the server 130, etc., indicating global position coordinates of the location transmitter 200. The computer 105 receives the global position coordinates of the location transmitter 200 via the network 125. The location transmitter 200 is stationary relative to the vehicle 101, i.e., the location transmitter 200 does not move relative to the vehicle 101. Thus, the vehicle 101 is mobile, i.e., the vehicle 101 moves relative to the location transmitter 200. The location transmitter 200 can be fixed or mounted to an infrastructure element, e.g., mounted to a pole, a roadway sign, etc.

The location transmitter 200 has a broadcast radius 210. The broadcast radius 210 is a distance around the location transmitter 200 that a receiver (e.g., the computer 105) can receive the global position coordinates transmitted by the location transmitter 200. The broadcast radius 210 can be, e.g., 5 meters.

The location transmitter 200 can be disposed at a specified lateral distance Δxₜ, i.e., a distance in the lateral direction x, from a roadway lane marking 215. That is, the lateral distance Δxₜ is the shortest absolute difference, i.e., the length of the shortest straight line, between the location transmitter 200 and the roadway lane marking 215, and is a difference in x coordinates from the location, i.e., geo-coordinates, of the location transmitter 200 to the roadway lane marking 215. In the 2-dimensional coordinate system, the roadway lane marking 215 substantially extends long the longitudinal direction x, so the shortest absolute distance between the location transmitter 200 and the roadway lane marking 215 is only along the lateral direction x. If the roadway lane marking 215 curves away from the longitudinal direction y within the broadcast radius 210, the computer 105 can define a line tangent to the curved roadway lane marking 215 at the x position of the roadway lane marking 215 when the vehicle 101 enters the broadcast radius 210, the tangent line being parallel to the longitudinal direction y. A curved roadway can be treated as if it is substantially straight for purposes herein, inasmuch as the typically relatively short distance of a radius 210 (5 meters or less) means that a curved road will not substantially or materially alter processing described herein. Upon installation of the location transmitter 200, the lateral distance Δxₜ can be measured and stored in a data store of the location transmitter 200. The location transmitter 200 can broadcast the lateral distance Δxₜ within the broadcast radius 210.

When the vehicle 101 enters the broadcast radius 210, the computer 105 receives the global position coordinates, the broadcast radius 210, and the lateral distance Δxₜ of the location transmitter 200. The computer 105 can determine a lateral distance Δxᵥ between the vehicle 101 and the roadway lane marking 215, e.g., based on image data 115 from a sensor 110 indicating a distance between the vehicle 101 along the lateral direction x and the roadway lane marking 215 and a position of the vehicle 101 at the reference point O along the lateral direction x.

The computer 105 can determine a longitudinal distance Δy between the vehicle 101 and the location transmitter 200. Because the broadcast radius 210 has a predetermined distance r, the computer 105 can determine the longitudinal distance Δy with the Pythagorean theorem, i.e., Δy=\sqrt{r²=(Δxᵥ+Δxₜ)²}.

The computer 105 can determine an initial position (xᵥ, yᵥ) upon entering the broadcast radius 210. The “initial position” is the set of (x, y) coordinates of the vehicle 101 at the reference point O when the reference point O enters the broadcast radius 210. The initial position xᵥ, yᵥ can be determined based on the global position coordinates xₜ,yₜ, the lateral distance Δx, and the longitudinal distance Δy:

(xᵥ, yᵥ)=(xₜ−Δx, yₜ−y) (1)

The computer 105 can determine a localized trajectory 220 of the vehicle 101. In the present context, a “localized trajectory” 210 is a predicted path of the vehicle 101 from a previously identified vehicle position, e.g., the initial position (xᵥ, yᵥ,) to a current position of the vehicle 101. FIG. 2A shows the vehicle 101 following a localized trajectory 220 from a previously identified vehicle position approaching the location transmitter 200. Upon reaching the location transmitter 200, the computer 105 determines a new localized trajectory based on the newly identified vehicle position (xᵥ, yᵥ). As described below, the computer 105 can determine the localized trajectory 220 based on data 115 regarding, e.g., dead reckoning, low-resolution GPS signals, etc., and an elapsed time from leaving the initial position.

The computer 105 can determine the localized trajectory 220 based on data 115 about vehicle 101 movement after the initial position. For example, the computer 105 can determine a localized trajectory based on the global position coordinates from the location transmitter 200 and dead reckoning of the vehicle 101. In this context, “dead reckoning” is the determination of a trajectory of the vehicle from a previously determined position, the position determined from the previous position (i.e., location) from vehicle 101 data collected after passing that previously determined position. Upon receiving the global position coordinates of the location transmitter 200, the computer 105 can send global position coordinates and a timestamp of a time at which the vehicle 101 left the broadcast radius 210 to the server 130. Then, to determine the localized trajectory 220, the computer 105 can request the previously stored global position coordinates of the location transmitter 200 and the timestamp from the server 130. The computer 105 can use data 115 collected after the timestamp to determine the localized trajectory 220 by dead reckoning from the global position coordinates of the location transmitter 200. For example, the computer 105 can use data 115 from a wheel encoder and/or internal measurement units (IMU) indicating a vehicle 101 speed, yaw angle, pitch angle, roll angle, acceleration, etc. Based on the data 115 collected from the wheel encoder and/or the IMU and the elapsed time from leaving the initial position, the computer 105 can determine the localized trajectory 220.

In another example, the computer 105 can use low-resolution GPS signals from the server 130 to determine the localized trajectory 220. GPS signals typically provide locations within a distance resolution, i.e., the location coordinates are accurate to the distance resolution. Smaller resolutions require additional computational resources. In this context, a “low-resolution” GPS can have a distance resolution of about 1 meter (m), and “high-resolution” GPS can have a distance resolution of about 0.1 m. That is, location coordinates from low-resolution GPS signals can be accurate to within 1 m, and location coordinates from high-resolution GPS signals can be accurate to within 0.1 m. The server 130 can determine low-resolution GPS more quickly and with fewer computational resources than high-resolution GPS typically used vehicle 101 navigation, and the computer 105 can request the low-resolution GPS signals indicating the current vehicle position from the global position coordinates of the location transmitter 200. The computer 105 can identify a vehicle position from the low resolution GPS signals and determine a path traveled from the global position coordinates of the location transmitter 200 to the vehicle position. Based on the path and a time elapsed from leaving the broadcast radius 210, the computer 105 can determine the localized trajectory 220 of the vehicle 101 from the location transmitter 200.

The computer 105 can identify a current vehicle position based on the localized trajectory 220 and the initial position. When the computer 105 moves the vehicle 101 along the path, the computer 105 can use the current vehicle position to determine whether the vehicle 101 is following the path 205. The computer 105 determine a difference between the global position coordinates from a location transmitter 200 and a vehicle position determined by the computer 105, and the computer 105 can correct errors from the path 205 by the difference. Thus, the computer 105 can more accurately determine the current vehicle position and reduce errors from the path 205 than relying on onboard computer 105 position determining techniques, e.g., dead reckoning from the origin of the path 205.

The computer 105 can actuate one or more components 120 to return the vehicle 101 to the path 205 based on the current vehicle position. For example, the computer 105 can use conventional virtual driver and/or ADAS techniques to identify the current position of the vehicle 101 and the position prescribed by the path 205, and to actuate one or more components 120 (e.g., a steering component 120, a propulsion 120, a brake 120, etc.) to move the vehicle from the current position to the prescribed position along the path 205 without user input. That is, the virtual driver can identify a difference between the current position and the prescribed position along the path 205, can identify a specified steering torque to provide a steering angle to steer the vehicle 101 to the prescribed position, and can instruct a steering control module to actuate a steering assist motor to provide the steering angle.

The computer 105 can determine a first localized trajectory 220 from the origin of the path to current location coordinates prescribed by the path 205. The computer 105 can determine a second localized trajectory 225 from an initial position of the vehicle 101 defined by global position coordinates of the location transmitter 200. That is, the path 205 includes position coordinates from which the computer 105 can determine the first localized trajectory 220 to determine the current vehicle position. As the vehicle 101 follows the path 205, errors in data 115 collection by vehicle sensors 110 can cause the first localized trajectory 220 to deviate from the path 205. Thus, the second localized trajectory 225, determined based on the global position coordinates of the location transmitter 200, unaffected by errors in the sensors 110, can more accurately follow the path 205 than the first localized trajectory 220. When a difference between the first localized trajectory 220 and the second localized trajectory 225 exceeds a threshold, the computer 105 can actuate one or more components 120 to follow the second localized trajectory 225. The threshold can be a resolution of a sensor 110 from which data 115 were gathered to determine the second localized trajectory 225, e.g., 1 meter. In the example of FIG. 2A, the computer 105 determined the first localized trajectory 220 and the second localized trajectory 225 from a previously identified vehicle position. Upon identifying the location transmitter 200 as shown in FIG. 2B, the computer 105 can, upon passing the location transmitter 200, determine a new localized trajectory based on the initial position (xᵥ, yᵥ). p Alternatively or additionally, the computer 105 can adjust the path 205 based on the global position coordinates of the location transmitter 200. Upon determining the initial position xᵥ, yᵥ, and the time indicated by the timestamp corresponding to the initial position xᵥ, yᵥ, the computer 105 can determine a path position Xₚₐₜₕ, yₚₐₜₕ at the timestamp. The computer 105 can determine an offset distance between the initial position xᵥ, yᵥ and the path position xₚₐₜₕ, yₚₐₜₕ, i.e., difference in the x and y coordinates between the initial position xᵥ, yᵥ and the path position xₚₐₜₕ, yₚₐₜₕ, and can adjust coordinates of the path 205 after the timestamp by the offset distance.

The computer 105 can determine the localized trajectory 220 upon determining that the vehicle 101 is not in a turn. A straight-moving vehicle 101 has fewer deviations in position, and the computer 105 can more readily determine the localized trajectory 220 based on data 115 having fewer deviations than deviations in position during a turn. The computer 105 can determine that the vehicle 101 is in a turn when data 115 from one or more sensors 110 indicate that the vehicle 101 is turning, e.g., a steering angle exceeds an angle threshold, a yaw rate exceeds a yaw rate threshold, etc. The angle threshold can be determined based on empirical testing of an example vehicle 101 moving into a perpendicular roadway lane and the steering angles to which the computer 105 moves the vehicle 101 to perform the turn. The yaw rate threshold can be determined based on empirical testing of an example vehicle 101 moving into the perpendicular roadway lane and the yaw rates achieved for the vehicle 101 to perform the turn.

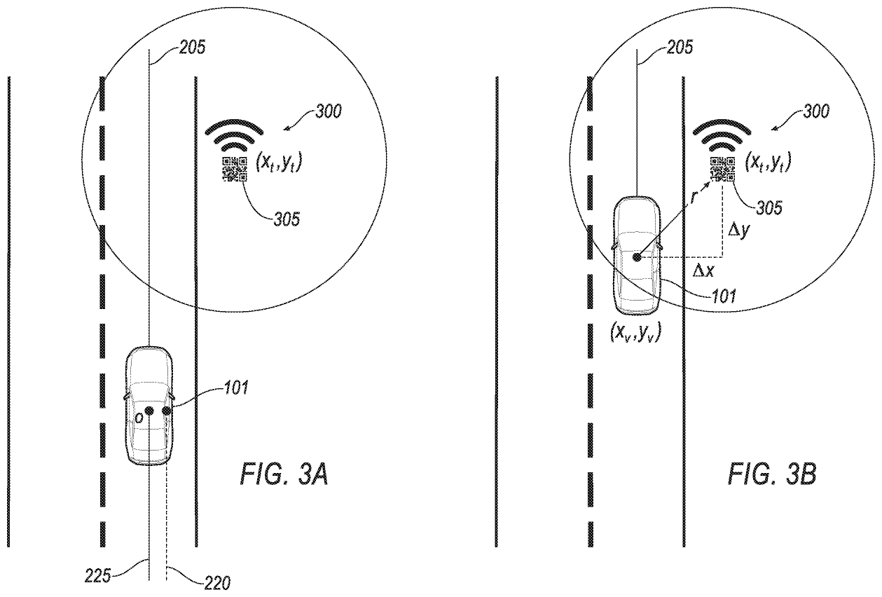

FIGS. 3A and 3B show a location transmitter 300 that includes a pattern 305. As described above, the location transmitter 300 transmits global position coordinates of the location transmitter 300 to one or more vehicles 101. The pattern 305 is a visual marking on an outer surface of the location transmitter 300. For example, the pattern 305 can be a substantially unique identifying barcode (e.g., a QR code or the like) that identifies the location transmitter 300.

The computer 105 can actuate one or more sensors 110 (e.g., an image sensor 110) to collect image data 115. Upon collecting an image of the pattern 305, the computer 105 can identify the pattern 305 and the corresponding location transmitter 300. Upon identifying the location transmitter 300, the computer 105 can receive global position coordinates from the location transmitter 300 over the network 125. Alternatively or additionally, upon identifying the location transmitter 300 with the pattern 305, the computer 105 can receive global position coordinates for the identified location transmitter from the server 130. Yet alternatively or additionally, the computer 105 can, upon identifying the location transmitter 300, send a request to the server 130 for global position coordinates for the identified location transmitter 300.

Upon identifying the location transmitter 300, the computer 105 can determine a lateral distance Δx and a longitudinal distance Δy between the vehicle 101 and the location transmitter 300. In the example of FIGS. 3A-3B, the computer 105 can, using conventional image processing techniques, determine an absolute distance r between the vehicle 101 and the location transmitter 300. The absolute distance r is the shortest linear distance between the vehicle 101 and the location transmitter 300. The computer 105 can determine, as described above, a distance Δxᵥ between the vehicle 101 and the roadway lane marking. As described above, the computer 105 can determine the lateral distance Δx and the longitudinal distance Δy based on the absolute distance r and the Pythagorean Theorem. The computer 105 can thus determine the initial position (xᵥ, yᵥ) according to Equation 1 above.

The computer 105 can determine a current vehicle position from the initial position (xᵥ, yᵥ,) determined upon identifying the location transmitter 300 following the localized trajectory 220. As described above, the computer 105 can determine the localized trajectory 220 based on, e.g., dead reckoning, low-resolution GPS, etc. In the example of FIG. 3A, the computer 105 determined the localized trajectory 220 and a second localized trajectory 225 based on a previously identified vehicle position, e.g., based on a previously identified location transmitter 300. Upon identifying the location transmitter 300 as shown in FIG. 3B, the computer 105 can, upon passing the location transmitter 300, determine a new localized trajectory based on the initial position (xᵥ, yᵥ).

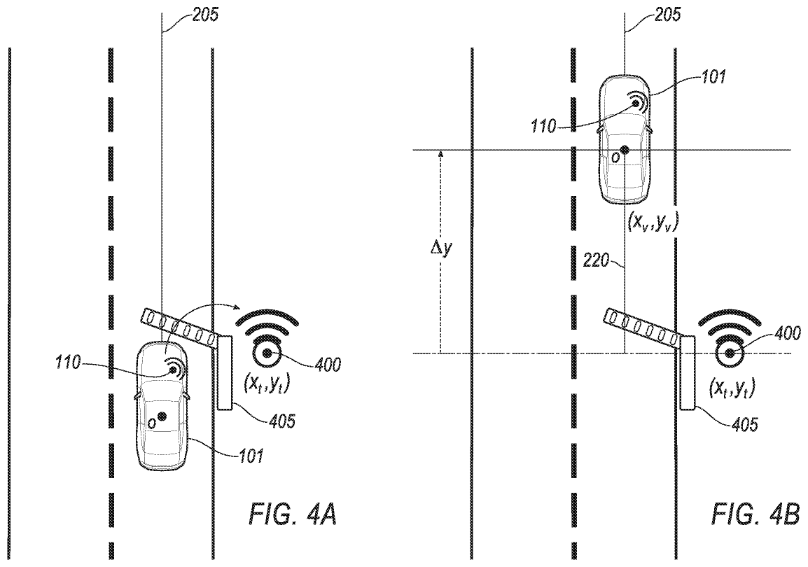

FIGS. 4A and 4B show the vehicle 101 approaching a location transmitter 400 at a landmark 405. The landmark 405 can be, e.g., a toll gate onto a roadway, a pole, an overpass, etc. In FIG. 4A, the vehicle 101 approaches the landmark 405. The computer 105 identifies the location transmitter 400 and receives the global position coordinates of the location transmitter 400 when passing through the landmark 405 with a sensor 110. For example, the computer 105 can receive the global position coordinates of the location transmitter 400 with a radio-frequency identification (RFID) receiver 110.

Upon receiving the global position coordinates of the location transmitter 400, the computer 105 can determine the localized trajectory 220 from the location transmitter 400. As described above, the computer 105 can determine the localized trajectory 220 based on, e.g., dead reckoning, low-resolution GPS, etc. Upon determining the localized trajectory 220, the computer 105 can determine the vehicle position. Based on the vehicle position, the computer 105 can actuate one or more components 120 to return the vehicle 101 to the path 205.

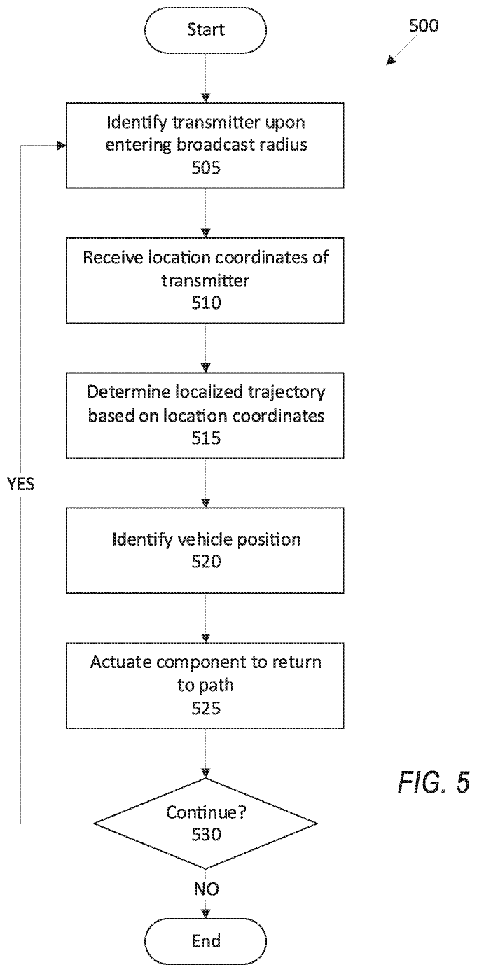

FIG. 5 illustrates an example process 500 for determining a position of a vehicle 101, typically carried out by the computer 105 according to stored program instructions. The process 500 begins in a block 505, in which the computer 105 identifies a location transmitter 200 when the vehicle 101 enters a broadcast radius 210. As described above, the computer 105 can detect that the vehicle 101 has entered the broadcast radius 210 upon receiving a signal from the location transmitter 200.

Next, in a block 510, the computer 105 receives global position coordinates of the location transmitter 200. The computer 105 can receive the global position coordinates from the location transmitter 200 over the network 125. The computer 105 can further receive the distance r of the broadcast radius 210 from the location transmitter 200.

Next, in a block 515, the computer 105 determines a localized trajectory 220 based on the global position coordinates of the location transmitter 200. As described above, the computer 105 can determine an initial position (xᵥ, yᵥ) of the vehicle 101 upon entering the broadcast radius 210 based on the global position coordinates (xₜ, yₜ). Based on the initial position (xᵥ, yᵥ), the computer 105 can determine the localized trajectory based on, e.g., dead reckoning, low-resolution GPS, etc.

Next, in a block 520, the computer 105 identifies a current vehicle position. As described above, the computer 105 identifies the vehicle 101 position based on the global position coordinates of the location transmitter 200 and the localized trajectory 220 of the vehicle 101 upon entering the broadcast radius 210.

Next, in a block 525, the computer 105 actuates one or more components 120 to return the vehicle 101 to a path 205. For example, as described above, the computer 105 can use conventional virtual driver and/or ADAS techniques to identify the current position of the vehicle 101, the position prescribed by the path 205, and to actuate one or more components 120 (e.g., a steering component 120, a propulsion 120, a brake 120, etc.) to move the vehicle from the current position to the prescribed position along the path 205. Because the vehicle position based on the global position coordinates of the location transmitter 200 is more accurate than the position prior to approaching the location transmitter 200, the computer 105 can correct the vehicle 101 to the path 205 based on the vehicle 101 position.

Next, in a block 530, the computer 105 determines whether to continue the process 500. For example, the computer 105 can determine to continue the process 500 if the vehicle 101 is still on the path 205. If the computer 105 determines to continue, the process 500 returns to the block 505. Otherwise, the process 500 ends.

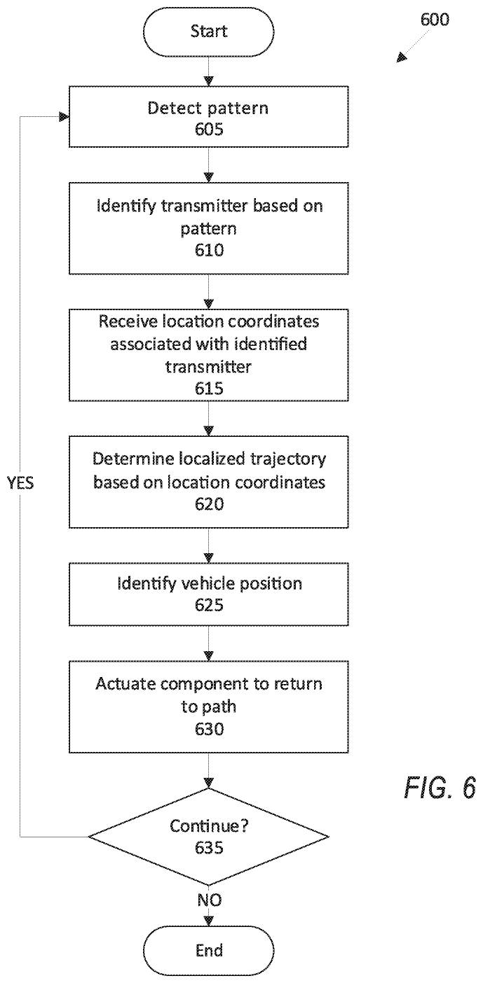

FIG. 6 illustrates an example process 600 for determining a position of a vehicle 101. The process 600 begins in a block 605, in which the computer 105 detects a pattern 305 based on collected image data 115. The computer 105 can then use one or more conventional image processing techniques to identify the pattern 305, e.g., a pattern-recognition algorithm such as is known to identify barcodes, QR codes, etc.

Next, in a block 610, the computer 105 identifies a location transmitter 300 associated with the detected pattern 305. As described above, the computer 105 can have a plurality of patterns 305 stored in the data store 106 and/or the server 130, each pattern 305 associated with a specific location transmitter 300. Upon identifying the pattern 305, the computer 105 can determine the specific location transmitter 300 associated with the identified pattern 305.

Next, in a block 615, the computer 105 receives global position coordinates from the location transmitter 300. As described above, the location transmitter 300 can send the global position coordinates to the computer 105 over the network 135.

Next, in a block 620, the computer 105 determines a localized trajectory 220 based on the global position coordinates of the location transmitter 300. The computer 105 can determine an initial position of the vehicle 101 based on the global position coordinates of the location transmitter 300 and an identified absolute distance r between the location transmitter 300 and the vehicle 101. As described above, the computer 105 can determine the localized trajectory 220 based on, e.g., dead reckoning, low-resolution GPS, etc.

Next, in a block 625, the computer 105 identifies a current vehicle position based on the localized trajectory 220. As described above, the computer 105 can determine the current vehicle position based on the path from the initial position along the localized trajectory 220.

Next, in a block 630, the computer 105 actuates one or more components 120 based on the vehicle 101 position. For example, as described above, the computer 105 can use conventional virtual driver and/or ADAS techniques to identify the current position of the vehicle 101, the position prescribed by the path 205, and to actuate one or more components 120 (e.g., a steering component 120, a propulsion 120, a brake 120, etc.) to move the vehicle from the current position to the prescribed position along the path 205. Because the vehicle position based on the global position coordinates of the location transmitter 300 is more accurate than the position prior to approaching the location transmitter 300, the computer 105 can correct the vehicle 101 to the 205 based on the vehicle 101 position.

Next, in a block 635, the computer 105 determines whether to continue the process 600. For example, the computer 105 can determine to continue the process 600 if the vehicle 101 is still on the path 205. If the computer 105 determines to continue, the process 600 returns to the block 605. Otherwise, the process 600 ends.

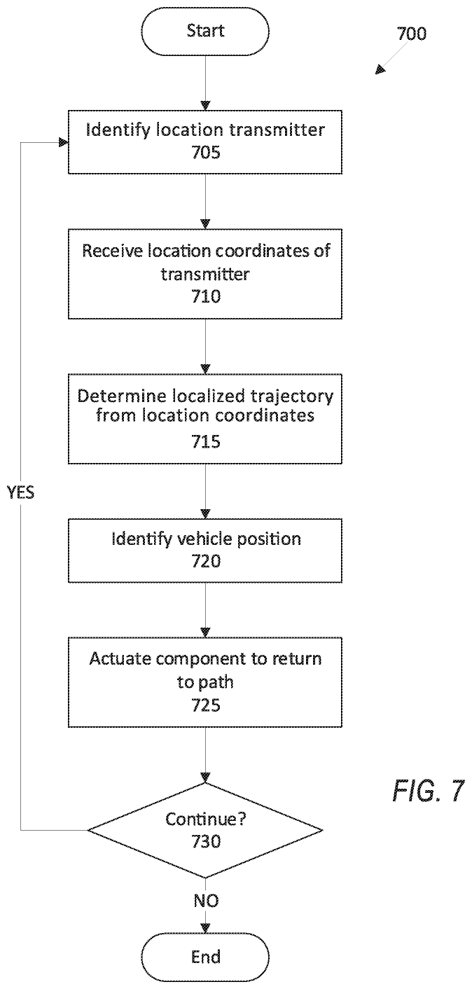

FIG. 7 is a block diagram of an example process 700 for determining a position of a vehicle 101. The process 700 begins in a block 705, in which the computer 105 identifies a location transmitter 400 at a landmark 405. For example, the computer 105 can identify the location transmitter 400 based on an RFID identification signal or the like.

Next, in a block 710, the computer 105 receives global position coordinates of the location transmitter 400. As described above, the computer 105 can receive the global position coordinates from the location transmitter 400 over the network 125.

Next, in a block 715, the computer 105 determines a localized trajectory 220 of the vehicle 101 from the global position coordinates of the location transmitter 400. As described above, the computer 105 can determine the localized trajectory based on, e.g., dead reckoning, low-resolution GPS, etc.

Next, in a block 720, the computer 105 identifies a current vehicle position. As described above, the computer 105 can determine the current vehicle position based on the path from the initial position along the localized trajectory.

Next, in a block 725, the computer 105 actuates one or more components 120 to return the vehicle 101 to a path 205. For example, as described above, the computer 105 can use conventional virtual driver and/or ADAS techniques to identify the current position of the vehicle 101, the position prescribed by the path 205, and to actuate one or more components 120 (e.g., a steering component 120, a propulsion 120, a brake 120, etc.) to move the vehicle from the current position to the prescribed position along the path 205. Because the vehicle position based on the global position coordinates of the location transmitter 400 can be more accurate than the position determined by the computer 105 prior to approaching the location transmitter 400, the computer 105 can correct the vehicle 101 to the 205 based on the vehicle 101 position.

Next, in a block 730, the computer 105 determines whether to continue the process 700. For example, the computer 105 can determine to continue the process 700 if the vehicle 101 is still on the path 205. If the computer 105 determines to continue, the process 700 returns to the block 705. Otherwise, the process 700 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computing devices discussed herein, including the computer 105 and server 130 include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 500, one or more of the steps could be omitted, or the steps could be executed in a different order than shown in FIG. 5. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a computer including a processor and a memory, the memory including instructions executable by the processor to:
identify a mobile vehicle position based on global position coordinates of a stationary location transmitter and a localized trajectory of a vehicle that is based on vehicle component data collected after passing the stationary location transmitter; and
actuate a vehicle component based on the identified vehicle position.

2. The system of claim 1, wherein the instructions further include instructions to determine the localized trajectory upon determining that the vehicle has entered a broadcast radius of the location transmitter.

3. The system of claim 1, wherein the instructions further include instructions to determine the localized trajectory upon detection of the location transmitter in an image.

4. The system of claim 3, wherein the instructions further include instructions to identify a pattern with the image sensor and to determine the localized trajectory based on global position coordinates corresponding to the location transmitter associated with the pattern.

5. The system of claim 1, wherein the instructions further include instructions to determine the localized trajectory based on global position coordinates from a previously identified location transmitter.

6. The system of claim 5, wherein the instructions further include instructions to determine the localized trajectory based on a vehicle speed identified after receiving the global position coordinates from the previously identified location transmitter.

7. The system of claim 1, wherein the instructions further include instructions to determine the localized trajectory based on wheel rotation data.

8. The system of claim 1, wherein the instructions further include instructions to determine a second localized trajectory based on global position coordinates of the vehicle and to actuate a component to move the vehicle along the second localized trajectory when a difference between the localized trajectory and the second localized trajectory exceeds a threshold.

9. The system of claim 1, wherein the instructions further include instructions to determine a second localized trajectory based on the identified vehicle position.

10. The system of claim 1, wherein the instructions further include instructions to determine a path from an origin to a destination and to adjust the path based on the global position coordinates of the location transmitter.

11. The system of claim 1, wherein the location transmitter is fixed to infrastructure.

12. The system of claim 1, wherein the instructions further include instructions to determine the localized trajectory upon determining that the vehicle is not in a turn.

13. A method, comprising:
identifying a mobile vehicle position based on global position coordinates of a stationary location transmitter and a localized trajectory of a vehicle that is based on vehicle component data collected after passing the stationary location transmitter; and
actuating a vehicle component based on the identified vehicle position.

14. The method of claim 13, further comprising determining the localized trajectory upon determining that the vehicle has entered a broadcast radius of the location transmitter.

15. The method of claim 13, further comprising determining the localized trajectory upon detection of the location transmitter with an image sensor.

16. The method of claim 13, further comprising determining the localized trajectory based on global position coordinates from a previously identified location transmitter.

17. A system, comprising:
a steering component of a vehicle;
means for identifying a mobile vehicle position based on global position coordinates of a stationary location transmitter and a localized trajectory of a vehicle that is based on vehicle component data collected after passing the stationary location transmitter; and
means for actuating the steering component based on the identified vehicle position.

18. The system of claim 17, further comprising means for determining the localized trajectory upon determining that the vehicle has entered a broadcast radius of the location transmitter.

19. The system of claim 17, further comprising means for determining the localized trajectory upon detection of the location transmitter with an image sensor.

20. The system of claim 17, further comprising means for determining the localized trajectory based on global position coordinates from a previously identified location transmitter.
